(19) United States
(12) Patent Application Publication
(10) Pub. No.: US 2010/0017040 A1
(43) Pub. Date: Jan. 21, 2010

(54) STACKED DISPLAYS WITH INDEPENDENT POWER AND INPUT SOURCES

(75) Inventor: Walter T. Shuler, Greensboro, NC (US)

Correspondence Address: Nelson Mullins Riley & Scarborough LLP;IP Department, 100 North Tryon Street, 42nd Floor, Charlotte, NC, 28202-4000, US

(73) Assignee: GILBARCO INC., Greensboro, NC (US)

(21) Appl. No.: 12/499,945

(22) Filed: Jul. 9, 2009

Related U.S. Application Data
(60) Provisional application No. 61/082,355, filed on Jul. 21, 2008.

(51) Int. Cl. G05D 7/00; B67D 5/22; G02F 1/13

(52) U.S. Cl. 700/282; 222/23; 349/1

(57) ABSTRACT

A fuel dispenser comprises a housing, a dispensing hose, a pump operatively connected to the dispensing hose and a source of fuel. A computer is operatively connected to the pump, a power supply is operatively connected to the computer and an auxiliary power supply is operatively connected to the computer. The auxiliary power supply is configured to provide power for a predetermined amount of time if the power supply should fail. A first display has a rear polarizing layer and a front polarizing layer. The first display is mounted in the housing so that the front polarizing layer is viewable by a user. A second display has only a front polarizing layer positioned adjacent to the first display front polarizing layer so that the first display projects an image through the second display. The first display and the second display are operatively connected to the power supply and the computer. The second display is operatively connected to the auxiliary power supply.

### CLAIM OF PRIORITY

The present application claims priority to U.S. Provisional Patent Application Ser. No. 61/082,355, filed Jul. 21, 2008, entitled Stacked Displays with Independent Power and Input Sources, the entire disclosure of which is incorporated by reference herein.

### FIELD OF THE INVENTION

The present invention relates to an improved display, and in particular is directed to stacked displays having independent power and data sources for use in gasoline dispensers.

### BACKGROUND OF THE INVENTION

Gasoline dispensers have evolved over the years from having mechanical dial readouts to LED displays to more recent liquid crystal displays. They have also evolved by having enhanced internal controller technology, including recent advances by Gilbarco, Inc. in the marketing of its THE ADVANTAGE™ ENCORE™ or ECLIPSE™ line of fuel dispensers, which include card readers that enable credit cards to be read by the gas dispenser, transaction displays for displaying the amount of gasoline pumped and the total cost, and additional displays for advertising and marketing. However, as displays are made larger and dispensers are made smaller, the amount of bezel area is consumed thereby limiting the size of the displays that can be integrated into the dispenser.

Thus, a need exists in the art for displays that can increase the amount of information presented while occupying a small amount of bezel area.

### SUMMARY OF THE INVENTION

The present invention recognizes and addresses disadvantages of prior art constructions and methods, and it is an object of the present invention to provide an improved display system. This and other objects may be achieved by a fuel dispenser comprises a housing, a dispensing hose, a pump operatively connected to the dispensing hose and a source of fuel. A computer is operatively connected to the pump, a power supply is operatively connected to the computer and an auxiliary power supply is operatively connected to the computer. The auxiliary power supply is configured to provide power for a predetermined amount of time if the power supply should fail. A first display has a rear polarizing layer and a front polarizing layer. The first display is mounted in the housing so that the front polarizing layer is viewable by a user. A second display has only a front polarizing layer positioned adjacent to the first display front polarizing layer so that the first display projects an image through the second display. The first display and the second display are operatively connected to the power supply and the computer. The second display is operatively connected to the auxiliary power supply.

In other embodiments, the auxiliary power supply is a battery. In yet other embodiments, the auxiliary power supply is a capacitor.

In some embodiments, the first and the second displays are independently connected to the power supply and the computer. In other embodiments, the first and the second displays are LCD displays. In yet other embodiments, the second display is lit from polarized light from the first display. In some embodiments, the system further comprises touch screen electronics.

In another preferred embodiment, a fuel dispenser comprises a dispenser housing, a dispenser system adapted to be connected to a fuel source, a computer operatively connected to the dispenser system, a power supply and a graphic display system mounted in the dispenser housing. The graphic display system comprises a first display having a front surface and a rear surface, the first display being operatively connected to the computer and the power supply and a second display having a front surface and a rear surface. The second display is positioned adjacent the first display so that the second display rear surface is adjacent the first display front surface, and the first and the second displays are independently connected to the power supply and the computer.

In other embodiments, the power supply comprises a main power source and an auxiliary power source. In some of these embodiments, the auxiliary power source is a battery. In others of these embodiments, the auxiliary power supply is a capacitor.

In yet other embodiments, the first and the second displays are LCD displays. In some embodiments, the first display is side lit. In other embodiments, the system comprises touch screen electronics. Still in other embodiments, the display system further comprises a first polarizing layer disposed on the first display rear surface and a second polarizing layer disposed on the first display front surface and a third polarizing layer disposed on the second display front surface.

In yet another preferred embodiment, a transaction terminal comprises a terminal housing, a computer, a power supply and a graphic display system mounted in the terminal housing. The graphic display system comprises a first display having a front surface and a rear surface, the first display being operatively connected to the computer and the power supply and a second display having a front surface and a rear surface, wherein the second display is positioned adjacent the first display so that the second display rear surface is adjacent the first display front surface. A first polarizing layer is disposed on the first display rear surface and a second polarizing layer disposed on the first display front surface. A third polarizing layer is disposed on the second display front surface. The second display rear surface does not contain a polarizing layer.

Various combinations and sub-combinations of the disclosed elements, as well as methods of utilizing same, which are discussed in detail below, provide other objects, features and aspects of the present invention.

The accompanying drawings, which are incorporated in and constitute a part of this specification, illustrate one or more embodiments of stacked displays of the present invention.

### BRIEF DESCRIPTION OF THE DRAWINGS

A full and enabling disclosure of the stacked displays having independent power and data sources, including the best mode thereof, directed to one of ordinary skill in the art, is set forth in the specification, which makes reference to the appended drawings, in which:

FIG. 1 is an elevation view of a prior art fuel dispenser;

FIG. 2 is a prior art block diagram of a service station illustrating major components;

FIG. 3 is a side view of a stacked display according to one embodiment of the present invention;

FIG. 4 is a perspective exploded view of the stacked display shown in FIG. 3;

FIG. 5 is perspective view of a fuel dispenser that includes the stacked display of FIG. 3;

FIG. 6 is a plan view of the stacked display of FIG. 3; and

FIG. 7 is a block diagram of various components of the electronics used in the dispenser of FIG. 5.

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

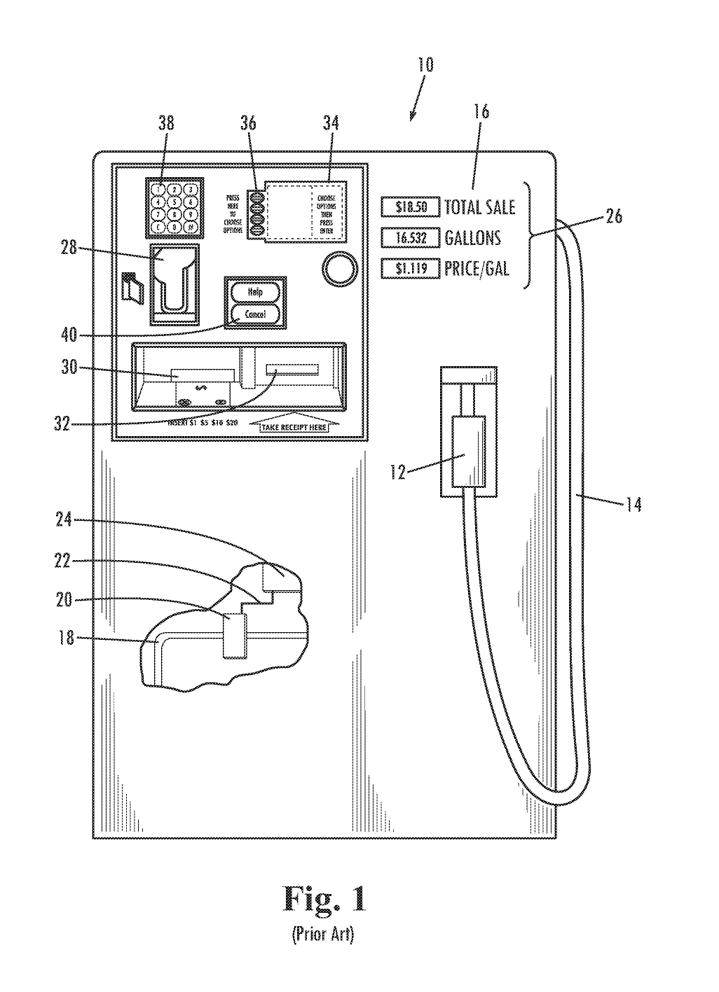

Referring to FIG. 1, a prior art dispenser 10 has a conventional nozzle 12 connected by a hose 14 to a dispenser housing 16, for dispensing gasoline or other fuel in a conventional fashion. The fuel is supplied from an underground reservoir (not shown) through a conduit 18 to hose 14. A metering device 20 from conduit 18 ascertains the volume of fuel delivered through conduit 18 and communicates that data over a line 22 to a microprocessor 24 in dispenser 10. The volume is used to compute and display transaction data on a conventional transaction display 26. Dispenser 10 also has a magnetic stripe card reader 28, a cash accepter 30, and a receipt printer 32, all of any desired design. The transactions in which components 28, 30 and 32 are involved are computed and ascertained by metering device 20, which also calculates and displays transaction information on display 26. Metering device 20 outputs signals to microprocessor 24, as conventional in products such as the Gilbarco line of CRIND™ (Card Reader IN Dispenser) dispensers sold under the trademark THE ADVANTAGE™ ENCORE™ or ECLIPSE™.

A video screen 34 can be seen displaying information concerning a carwash transaction, which can be elected by a customer in combination with a fueling transaction. Associated with video display 34 is a keypad 36 similar to those conventionally used with bank automated teller machine displays. That is, a plurality of keys 36 are aligned with the raster-scannable display 34 so that the effect of pressing one or more of keys 36 is explained to a user by the display on screen 34. Additional keypads 38 and 40 are provided for further transaction entry data to the microprocessor 24. If desired, the apparatus could be configured for data input through a touch screen.

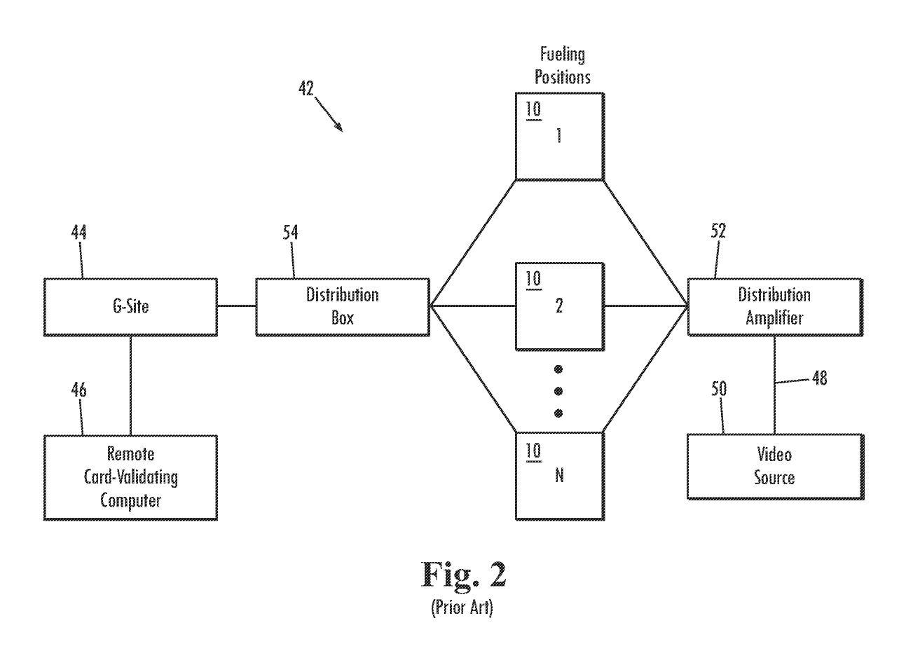

Referring to FIG. 2, a service station 42 has on site a plurality of fuel dispensers 10 connected through a single distribution box 54 to a site controller 44. A site controller 44 is preferably the G-Site™ or PASSPORT™ system controllers sold by Gilbarco, Inc. of Greensboro, N.C., and serves as an overall system controller for the multiplicity of fuel dispensers 10. Site controller 44 has a link to a remote credit- or debit- card-validating computer 46, such as a telephone link. Validating computer 46 may be hundreds or thousands of miles away from the service station at the site of a card-issuing authority or credit and debit card processor.

Controller 44 serves as a point-of-sale device somewhat like a cash register manned by an attendant, typically located in a kiosk or other store facility. Each of dispensers 10 is supplied with a video signal 48 from a video source 50 through a distribution amplifier 52. It should be appreciated that each of dispensers 10 is supplied with exactly the same signal, decreasing the investment required in video sources 50. Alternatively, multiple video sources may be provided so that the information provided to each dispenser display may be tailored to meet the needs or possible desires of the customer at each of dispensers 10. Video source 50 may be any conventional source of video signals such as a video tape recorder, a video disk, a live camera, an over-the-air or over-cable reception, internet connection or the like.

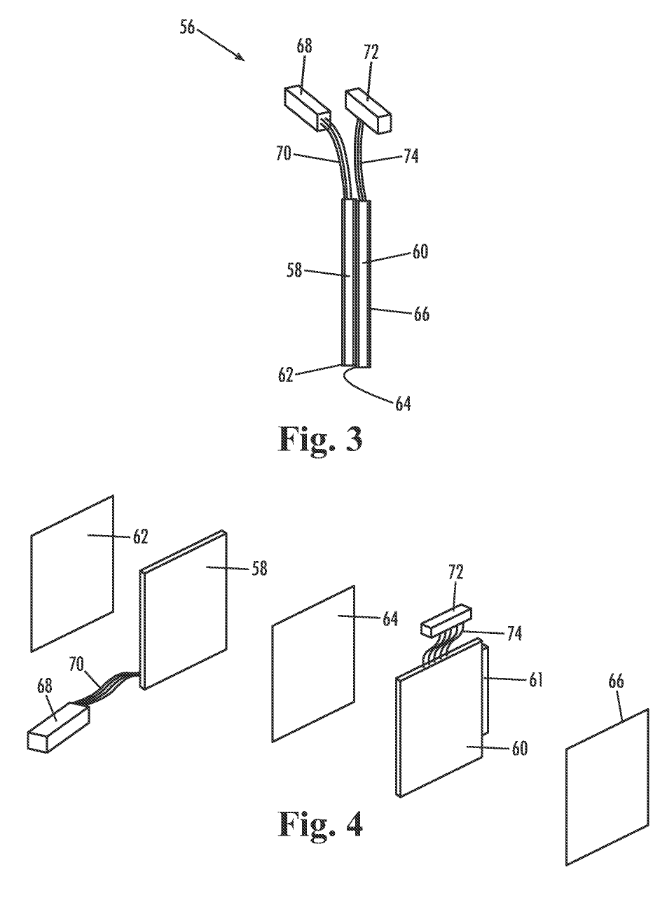

Referring to FIGS. 3 and 4, a stacked display 56 is shown having a first display 58 and a second display 60 positioned adjacent the first display. First and second display 58 and 60 may be any type of LCD display. First display 58 has a rear polarization layer 62 and a front polarization layer 64 coupled to the display. Second display 60 does not contain a rear polarization layer but has a front polarization layer 66. Rear display 58 may be backlit or side lit by a light 61 (FIG. 4), and is powered and controlled by a controller 68 connected to the display by lines 70. Second display 60, in preferred embodiments is powered and controlled by a controller 72 connected to the display by lines 74. In alternative embodiments, second display 60 may be backlit by extending the size of the display relative to the first display or by blocking a portion of first display 58. In one embodiment, first display 58 may be various LCD models, manufactured by, for example, OPTREX, and second display 60 may be a an LCD, manufactured by, for example, AMPIRE. One aspect of the present invention is to use the lighting generated from first screen 58 to enhance the image formed by second screen 60.

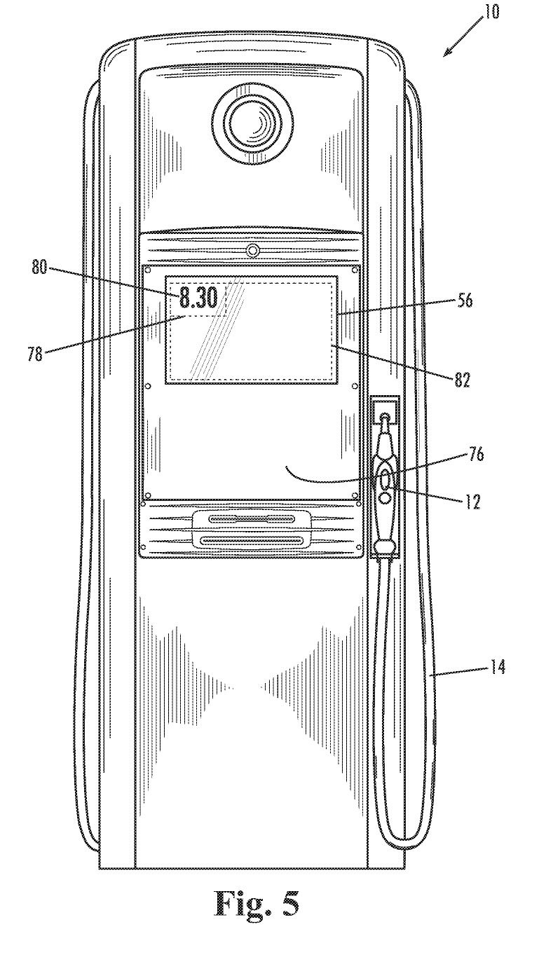

Referring to FIG. 5, stacked screen 56 is shown integrated into a gasoline dispenser 10. The use of stacked screen 56 allows for the use of a larger LCD display within the defined bounds of a dispenser bezel 76. That is, when second display 60 (FIG. 4) is not in use, a larger surface area is available to display advertising, marketing and related graphics. Referring to the figure, a transaction display area 78 may be predefined in second display 60 (FIG. 4) for displaying information 80 related to a dispensing transaction. The information displayed may include the amount of fuel dispensed, the cost per gallon, the total amount of the transaction, etc. It should be understood that second display 60 (FIG. 4) may include touch electronics that allows the customer to input information or complete a transaction at dispenser 10. Similar to second display 60 (FIG. 4), first display 58 (FIG. 4) may include a predefined viewing area 82 for displaying varying types of graphics, text and information.

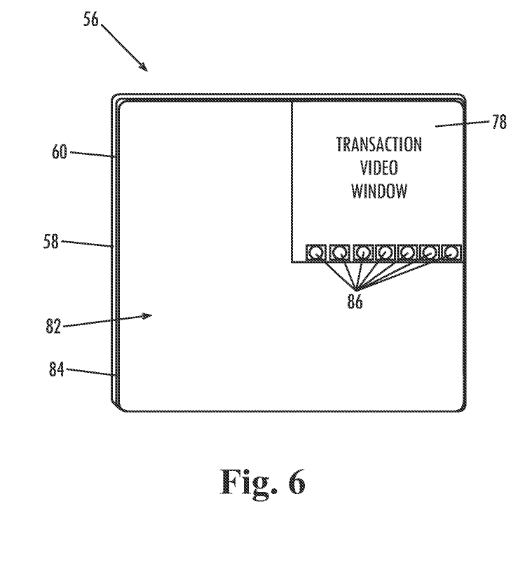

Referring specifically to FIG. 6, stacked display 56 is shown having transaction display area 78 in the upper right quadrant of the display. During a transaction, first display 58 may generate a solid colored background behind transaction display area 78 to enhance the readability of the data generated by display 60. Additionally, if touch electronics 84 are implemented, various soft buttons 86 may be provided to assist the user in entering data for the transaction. It should be understood that the shape, size and position of transaction display area 78 may vary depending on the application. When the dispenser is not engaged in a fuel dispensing transaction, transaction display area appears transparent so that the entire area of first display 58 can be utilized for marketing and advertising displays and transactions.

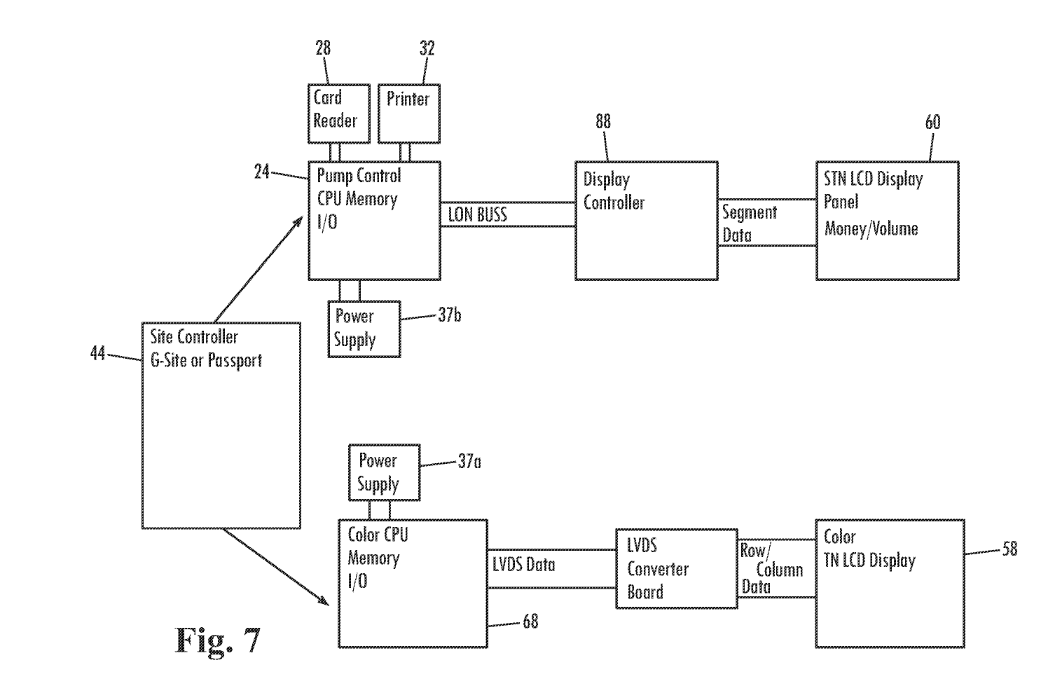

Referring to FIG. 7, the relationship of microprocessor 24 and the other electronic components of dispenser 10 is shown. Each of first display 58 and second display 60 are connected to a respective power source 37a and 37b. Power supply 37b also contains an auxiliary power supply so that the transaction display may continue to work during a power outage or some other event that interrupts the main power supply. The auxiliary power source may be a battery back-up or other suitable power supply such as a capacitor.

Site controller 44 has control over color controller 68 and microprocessor 24. Graphics for rear color display 58 are downloaded from site controller 44 and decompressed and stored in color controller 68, which are then presented on display 58. Pricing information and transactional information is transmitted between site controller 44 and microprocessor 24. Synchronization of the color controller 68 and microprocessor 24 is by RS232 serial communication. Transaction information is sent from microprocessor 24 to a display controller 88, which causes the information to be presented on front display 60. Microprocessor 24 also communicates with card reader 28 and printer 32.

While one or more preferred embodiments of the invention are described above, it should be appreciated by those skilled in the art that various modifications and variations can be made in the present invention without departing from the scope and spirit thereof. For example, the stacked display described herein may be used in various transaction terminals such as kiosks, ATM machines, self serve terminals and point-of-sale terminals. It is intended that the present invention cover such modifications and variations as come within the scope and spirit of the appended claims and their equivalents.

What is claimed is:

1. A fuel dispenser comprising:
a. a housing;
b. a dispensing hose;
c. a pump operatively connected to said dispensing hose and a source of fuel;
d. a computer operatively connected to said pump;
e. a power supply operatively connected to said computer;
f. an auxiliary power supply operatively connected to said computer, said auxiliary power supply configured to provide power for a predetermined amount of time if said power supply should fail;
g. a first display having a rear polarizing layer and a front polarizing layer, said first display mounted in said housing so that said front polarizing layer is viewable by a user; and
h. a second display having only a front polarizing layer positioned adjacent to said first display front polarizing layer so that said first display projects an image through said second display,
wherein
said first display and said second display are operatively connected to said power supply and said computer, and
said second display is operatively connected to said auxiliary power supply.

2. The fuel dispenser of claim 1, wherein said auxiliary power supply is a battery.

3. The fuel dispenser of claim 1, wherein said auxiliary power supply is a capacitor.

4. The fuel dispenser of claim 1, wherein said first and said second displays are independently connected to said power supply and said computer.

5. The fuel dispenser of claim 1, wherein said first and said second displays are LCD displays.

6. The fuel dispenser of claim 1, wherein said second display is lit from polarized light from said first display.

7. The fuel dispenser of claim 1, further comprising touch screen electronics.

8. A fuel dispenser comprising:
a. a dispenser housing;
b. a dispenser system adapted to be connected to a fuel source;
c. a computer operatively connected to said dispenser system;
d. a power supply; and
e. a graphic display system mounted in said dispenser housing, said graphic display system comprising,
i. a first display having a front surface and a rear surface, said first display being operatively connected to said computer and said power supply;
ii. a second display having a front surface and a rear surface, wherein said second display is positioned adjacent said first display so that said second display rear surface is adjacent said first display front surface,
wherein said first and said second displays are independently connected to said power supply and said computer.

9. The fuel dispenser of claim 8, wherein said power supply comprises a main power source and an auxiliary power source.

10. The fuel dispenser of claim 9, wherein said auxiliary power source is a battery.

11. The fuel dispenser of claim 9, wherein said auxiliary power supply is a capacitor.

12. The fuel dispenser of claim 8, wherein said first and said second displays are LCD displays.

13. The fuel dispenser of claim 8, wherein said first display is side lit.

14. The fuel dispenser of claim 8, further comprising touch screen electronics.

15. The fuel dispenser of claim 8, said display system further comprising:
a. a first polarizing layer disposed on said first display rear surface and a second polarizing layer disposed on said first display front surface, and
b. a third polarizing layer disposed on said second display front surface.

16. A transaction terminal comprising:
a. a terminal housing;
b. a computer;
c. a power supply; and
d. a graphic display system mounted in said terminal housing, said graphic display system comprising,
i. a first display having a front surface and a rear surface, said first display being operatively connected to said computer and said power supply;
ii. a second display having a front surface and a rear surface, wherein said second display is positioned adjacent said first display so that said second display rear surface is adjacent said first display front surface,
iii. a first polarizing layer disposed on said first display rear surface and a second polarizing layer disposed on said first display front surface, and
iv. a third polarizing layer disposed on said second display front surface,
wherein said second display rear surface does not contain a polarizing layer.

17. The transaction terminal of claim 16, wherein said power supply is a battery.

18. The fuel dispenser of claim 16, wherein said first and said second displays are independently connected to said power supply and said computer.

19. The fuel dispenser of claim 18, wherein said first and said second displays are LCD displays.

20. The fuel dispenser of claim 16, wherein said second display is lit from polarized light from said first display.
